(19) United States
(12) Patent Application Publication
(10) Pub. No.: US 2008/0140668 A1
(43) Pub. Date: Jun. 12, 2008

(54) Dedicated storage and background backup of stored contents

(76) Inventor: Bradley W. Corrion, Chandler, AZ (US)

Correspondence Address: INTEL CORPORATION;c/o INTELLEVATE, LLC, P.O. BOX 52050, MINNEAPOLIS, MN, 55402, US

(21) Appl. No.: 11/635,859

(22) Filed: Dec. 8, 2006

(51) Int. Cl. G06F 17/30

(52) U.S. Cl. 707/10; 707/E17.005

(57) ABSTRACT

In some embodiments information stored in a user storage device is sent to a service provider for backup, and a modified version of information stored in the user storage device is received from the service provider, where the modified version has been created by a remote user. Other embodiments are described and claimed.

### RELATED APPLICATION

This application is related to U.S. patent application Ser. No. “TO BE DETERMINED”, filed on even date herewith, entitled “Dedicated Storage and Background Backup of Stored Contents”, by Bradley W. Corrion.

### TECHNICAL FIELD

The inventions generally relate to dedicated storage and background backup of stored contents.

### BACKGROUND

Many service providers provide limited or unlimited storage of personal files in a dedicated online account. Some users have even been known to corrupt their use of email service providers to gain free online access to stored content. While this is helpful to a user to have their data stored in an offsite location, the downside to these solutions is that the user now has in existence two or more copies of their data. This makes it difficult for the user in determining which version of the data is the most accurate and up to date. Further, network backup services generally run on the host or client computer. This arrangement steals computational power from the user since the host or client computer is typically the user's personal desktop or laptop computer.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

FIG. 2 illustrates a flow chart according to some embodiments of the inventions.

FIG. 3 illustrates a flow chart according to some embodiments of the inventions.

FIG. 4 illustrates a flow chart according to some embodiments of the inventions.

FIG. 5 illustrates a flow chart according to some embodiments of the inventions.

### DETAILED DESCRIPTION

Some embodiments of the inventions relate to dedicated storage and background backup of stored contents.

In some embodiments a request of a remote user to access information stored in a user storage device is received and a determination is made as to whether a backup of the information is stored in a service provider storage device. If the backup of the information is stored in the service provider storage device, and if the information stored in the user storage device is more recent than the backup of the information stored in the service provider storage device, then the information stored in the user storage device is provided to the remote user.

In some embodiments a modified version of information stored in a user storage device is received from a remote user, and the modified version is stored at a service provider storage device.

In some embodiments a service provider computing device (for example, a server) includes a processor and a service provider storage device. The processor receives a request of a remote user to access information stored in a user storage device, and determines if a backup of the information is stored in the service provider storage device. If the backup of the information is stored in the service provider storage device, and if the information stored in the user storage device is more recent than the backup of the information stored in the service provider storage device, then the processor provides the information stored in the user storage device to the remote user.

In some embodiments information stored in a user storage device is sent to a service provider for backup, and a modified version of information stored in the user storage device is received from the service provider, where the modified version has been created by a remote user.

In some embodiments a storage device stores user information, and a processor sends the stored user information to a service provider for backup and receives a modified version of the user information from the service provider, where the modified version has been created by a remote user.

In some embodiments a request is received from a user for access to information stored on a storage device. A determination is made if a more recent version of the information is stored at a service provider. If a more recent version of the information is stored at the service provider, then the most recent version of the information stored at the service provider is provided to the user.

In some embodiments a storage device stores user information and a processor receives a request from a user for access to information stored on the storage device, determines if a more recent version of the information is stored at a service provider. If a more recent version of the information is stored at the service provider, the processor provides the most recent version of the information stored at the service provider to the user.

In some embodiments a device (for example, a network attached storage or NAS server) continuously analyzes, compresses, and backs up files residing on the storage device and transmits them to an online backup service provider. According to some embodiments these procedures are accomplished using an onboard processor of the device such as an Input/Output (I/O) processor of the device (I/O processor of the NAS server, for example).

Since many service providers offer online access to files from any location, a remote access model may be implemented according to some embodiments. For example, when a file is requested that has not been backed up, or that has been backed up but is out of date, the online service provider can actually pull the file from the remote storage device of the user (for example, a NAS server of the user). The pulled file is then stored and registered as the backup, and simultaneously provided to the remote user as requested. In some embodiments, if the user updates the file remotely, the service provider can then push the modifications back down to the storage device (after storing the backup).

According to some embodiments, two operational modes work together to transparently provide automatic backup and remote access to files stored on a dedicated storage device. The dedicate storage device (for example, a NAS device) routinely updates the status of its files to the service provider to schedule backups and speed online access from remote users. In some embodiments the device may use an access history algorithm to decide when to save incremental backups.

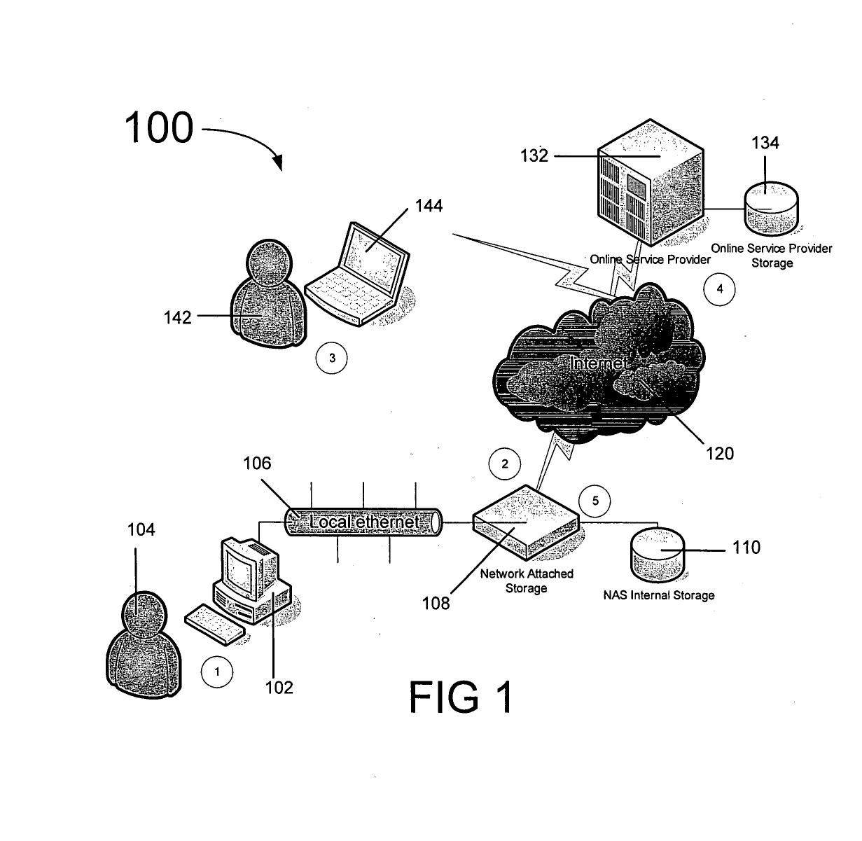

FIG. 1 illustrates a system 100 according to some embodiments. In some embodiments system 100 includes a user's network (for example, a Local Area Network, a home network, and/or an office network), the user's network including a computer 102 of a user 104, a local network connection (for example, a local Ethernet connection) 106, a storage device 108, and an internal storage 110 of the storage device 108. In some embodiments system 100 also includes an internet connection 120 and an online service provider network that includes an online service provider server 132 and online service provider storage 134. In some embodiments a remote user 142 can use a remote computer 144 to connect to the online service provider server 132 (for example, via the internet 120).

In some embodiments storage device 108 is a network attached storage (NAS) device (for example, a NAS server). In some embodiments storage device 108 includes an onboard processor (for example, an I/O processor) to continuously analyze, compress, and backup files residing on the storage device 108, transmitting them to the online service provider 132 (for example, via the internet 120). In some embodiments user 104 uses computer 102 to copy a file from the computer 102 (for example, a network attached computer) to the storage device 108 (for example, a NAS device). In some embodiments the storage device 108 analyzes, compresses, and backs up a copy of the file to the online service provider 132.

In some embodiments, online service provider 132 offers online access to files from any location to support a remote access model. The remote user 142 may seek to retrieve a file stored in their online account. The file may be requested by the remote user 142 using the remote computer 144. In some embodiments, the online service provider 132 checks to see if the file exists in the online service provider storage 134, and also checks to see if that file is the most recent copy. If the requested file is not the most recent copy (for example, it has not been backed up by the storage device 108 to the online service provider storage 134, or has been backed up to the online service provider storage 134 but is out of date), the online service provider 132 pulls the file from the remote storage device (for example, the internal storage 110 of the storage device 108). The file is then stored at the online service provider storage 134 and registered as the backup, and simultaneously (or very quickly thereafter) is provided to the remote user 142 as requested. If the user 142 updates the file remotely, the service provider 132 can then push the modifications back down to the storage device 108 (after storing the backup in the online service provider storage 134).

In some embodiments the storage device 108 and/or online service provider 132 perform automatic backup and remote access to files stored on the dedicated storage device 108 and/or 110. The storage device 108 routinely updates the status of its files to the online service provider 132 to schedule backups and speed online access from remote users. In some embodiments the storage device 108 may use an access history algorithm to decide when to save incremental backups.

According to some embodiments numerous and simple advantages of automatic backup are possible, particularly relative to existing solutions, which do not offer the number of capabilities or ease of functionality. While some connected network backup services exist, they generally run on the host or client computer, stealing computational power from the user. In some embodiments spare processing cycles of the processor of the storage device 108 are used to perform the automatic backup operations. Another advantage is that multiple clients are supported in an easy manner. Desktop-based or notebook-based backup services must coordinate how to backup a network attached storage device. For example, if all clients back up a network attached storage device, waste occurs. According to some embodiments any files on the network attached storage device are backed up. Another advantage of the automatic backup features include that client computers (for example, desktop and/or laptop client computers such as computer 102) can be left on or off as desired, since automatic backup occurs when the storage device 108 is left on (in some embodiments, for example, the storage device 108 is left on continuously). According to some embodiments the storage device 108 analyzes access behaviors to understand when it is optimal to send the backup, thus minimizing network traffic.

Many advantages also exist of the remote access features according to some embodiments. Many service providers exist to provide limited or unlimited storage of personal files in a dedicated online account. Some users even corrupt their use of email service providers to gain free online access to stored content. The downside to this concept is that the user now has two or more copies of their data in existence. According to some embodiments an advantage of the remote access features is that the user 104, 142 is provided with the illusion that there is only one copy of the file. Whether the user 104 and/or 142 accesses the copy stored by the online service provider 132 (for example, at online service provider storage 134), or the user 104 and/or 142 accesses the copy from their local network attached storage device 108 and/or 110, the modifications are transparently shared so that all interfaces are up to date.

Another advantage according to some embodiments is the always-on connection of the storage device 108 with the service provider 132. If a remote user 142 wishes to access a file which either is not backed up yet (still queued) or has been recently modified (and not yet backed up), the service provider 132 can use the copy on the storage device 108 (for example, the NAS server). The remote user 142 is not limited to solely what exists on the service provider's storage device 134.

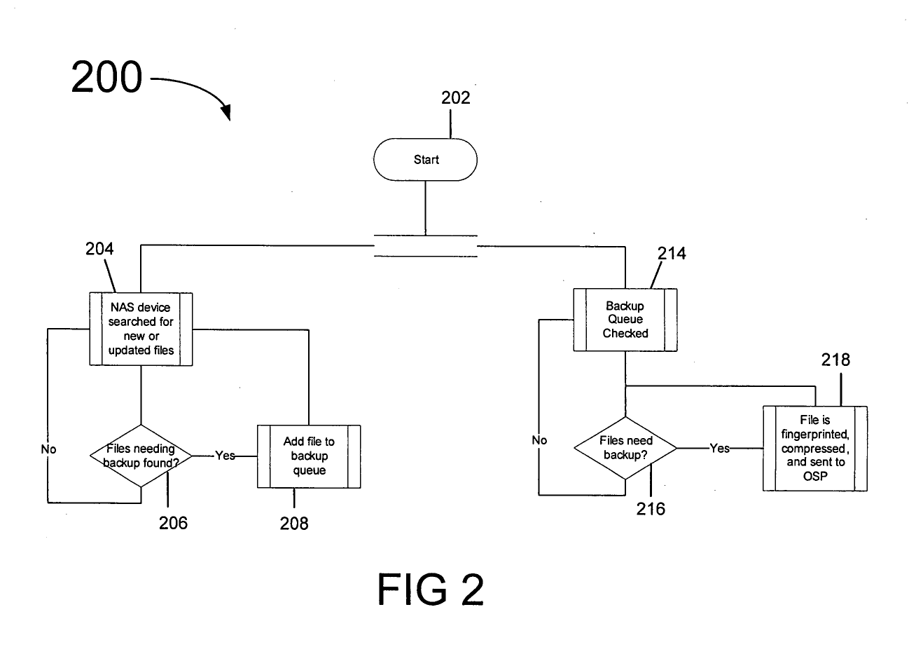

FIG. 2 illustrates a flowchart 200 according to some embodiments. Flow 200 starts at 202 and flow proceeds in two different directions (for example, simultaneously). One direction includes boxes 204, 206 and 208 and another direction includes boxes 214, 216 and 218.

At 204 a storage device (for example, a storage device such as storage device 108 and/or a NAS device) is searched for new or updated files. Then a determination is made at 206 as to whether or not files have been found that need backup. If 206 determines that there are files needing backup, then such files are added to a backup queue at 208, and flow is then returned to 204. If 206 determines that there are no files needing backup, then flow returns to 204 directly from 206.

At 214 the backup queue is checked, and flow moves to 216. At 216 a determination is made as to whether files are in the backup queue that need backup. If 216 determines that there is a file in the backup queue needing backup, then the file is fingerprinted, compressed, and sent to the online service provider (for example, such as online service provider 132), and flow is returned to 216 and 218 until all files in the backup queue have been sent to the service provider. If 216 determines that there are no files needing backup, then flow returns to 214 directly from 216. In some embodiments, it is noted that the flow of 214, 216, and/or 218 can be delayed (for example, such that the backup files are sent to the service provider when it is optimal in order to minimize network traffic).

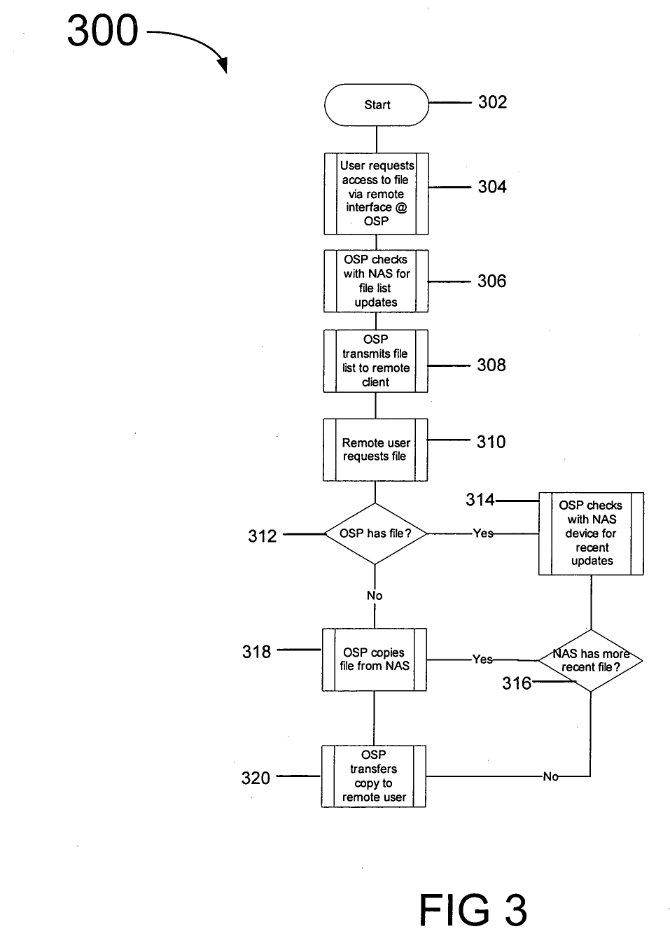

FIG. 3 illustrates a flowchart 300 according to some embodiments. In some embodiments flow 300 illustrates a flow for remote access retrieval of files, data, etc. Flow starts at 302 and moves to 304. At 304 a user requests access to a file via a remote interface at an online service provider. At 306 the online service provider checks with a storage device (for example, a remote storage device of a user such as storage device 108) for a list of file updates. At 308 the online service provider transmits the list of file updates to the remote client computer of the remote user. At 310 the remote user requests a file. At 312 a determination is made as to whether the online service provider has the file. If the online service provider has the file, the online service provider checks at 314 with the storage device (for example, NAS device) for recent updates. At 316 a determination is made as to whether the storage device (NAS device) has a more recent file. If the storage device (NAS device) has the more recent file at 316 the online service provider copies the file from the storage device (NAS device) at 318, and the online service provider transfers to the remote user the copy of the more recent file to the remote user at 320. Similarly, if the online service provider does not have the file at 312, the online service provider copies the file from the storage device (NAS device) at 318, and the online service provider transfers to the remote user the copy of the more recent file to the remote user at 320. If the storage device (NAS device) does not have the more recent file at 316, the online service provider transfers to the remote user a copy of the file from the online service provider storage at 320.

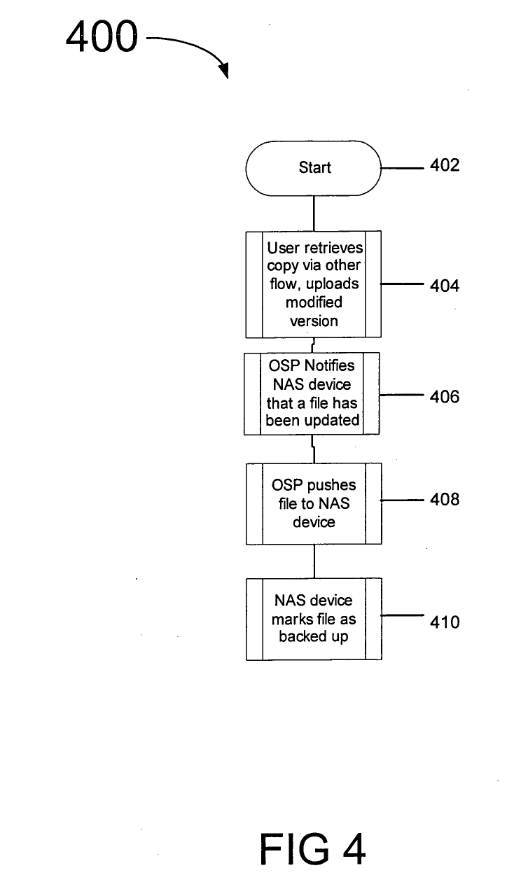

FIG. 4 illustrates a flowchart 400 according to some embodiments. In some embodiments flow 400 is a flow for a remote access update. Flow 400 starts at 402 and moves to 404. At 404 a remote user (for example, remote user 142) retrieves a copy of a file via another flow (for example, via a flow the same as or similar to flow 300), modifies the file, and uploads the modified version to an online service provider (for example, online service provider 132). At 406 the online service provider notifies a storage device (for example, storage device 108 and/or a NAS device) that a file has been updated. At 408 the online storage provider pushes the updated file to the storage device. At 410 the storage device stores the file and/or marks the file as being backed up.

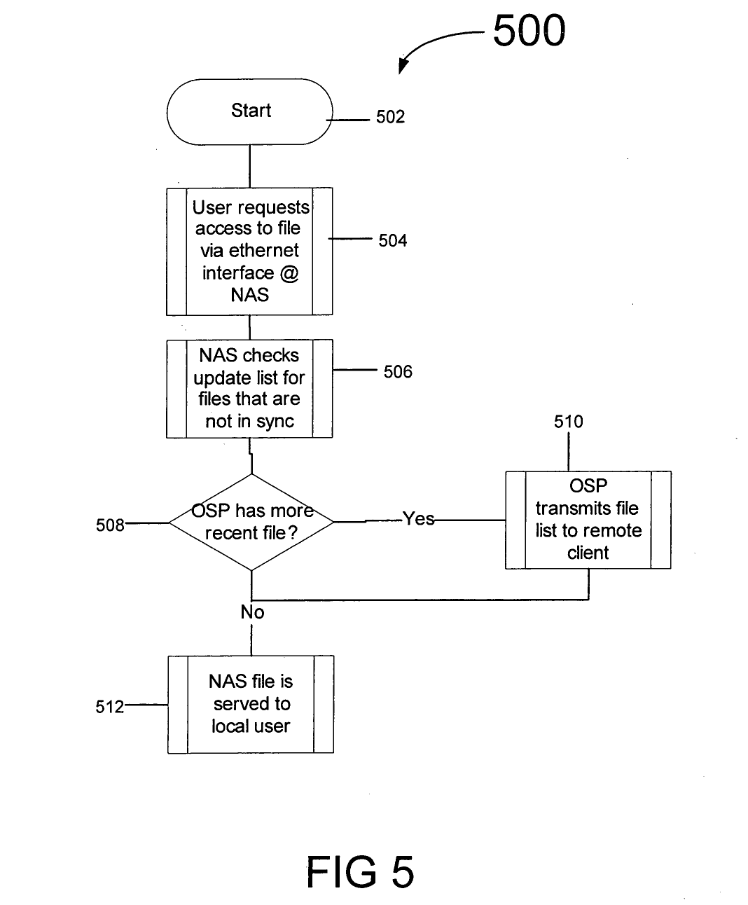

FIG. 5 illustrates a flowchart 500 according to some embodiments. In some embodiments flow 500 is a flow for local retrieval of user data. Flow 500 starts at 502 and moves to 504. At 504 a user (for example, user 104) requests access to a file at a storage device (for example, at storage device 108 and/or a NAS storage device via network 106 such as an Ethernet network). At 506 the storage device checks an update list for files that are not in sync. At 508 a determination is made as to whether a more recent file is at a service provider (for example, an online service provider such as service provider computing device 132 and/or service provider storage device 134). If a more recent file is at the service provider the service provider transmits the file list to the remote client at 510 and the file is provided to the local user at 512 and/or stored at the local storage device. If a more recent file is not at the service provider at 508, the file is directly provided from the local storage device to the user at 512.

According to some embodiments some or all of the flows 200, 300, 400 and/or 500 are implemented in software running on an online service provider computing device and/or a user computing device (for example, running on online service provider server 132 and/or storage device 108, and/or on a processor of online service provider server 132 and/or a processor of storage device 108). According to some embodiments some or all of the flows 200, 300, 400 and/or 500 are implemented using a processor of a storage device (for example, using a processor of storage device 108 such as an I/O processor).

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method comprising:
receiving a request of a remote user to access information stored in a user storage device;
determining if a backup of the information is stored in a service provider storage device;
if the backup of the information is stored in the service provider storage device, and if the information stored in the user storage device is more recent than the backup of the information stored in the service provider storage device, then providing the information stored in the user storage device to the remote user.

2. The method of claim 1, further comprising:
if the backup of the information is stored in the service provider storage device, and if the information stored in the user storage device is not more recent than the backup of the information stored in the service provider storage device, then providing the information stored in the service provider storage device to the remote user.

3. The method of claim 2, further comprising:
if a backup of the information is not stored in the service provider storage device, then providing the information stored in the user storage device to the remote user.

4. The method of claim 1, further comprising:
if a backup of the information is not stored in the service provider storage device, then providing the information stored in the user storage device to the remote user.

5. The method of claim 1, wherein a storage location from which information is provided to the remote user is transparent to the remote user.

6. The method of claim 3, wherein a storage location from which information is provided to the remote user is transparent to the remote user.

7. A method comprising:
receiving from a remote user a modified version of information stored in a user storage device; and
storing the modified version at a service provider storage device.

8. The method of claim 7, further comprising sending the modified version to the user storage device.

9. The method of claim 7, further comprising sending an indication to the user storage device that the modified version has been stored at the service provider storage device.

10. An apparatus comprising:
a service provider computing device including a processor and a service provider storage device;
wherein the processor is to receive a request of a remote user to access information stored in a user storage device, and to determine if a backup of the information is stored in the service provider storage device;
wherein if the backup of the information is stored in the service provider storage device, and if the information stored in the user storage device is more recent than the backup of the information stored in the service provider storage device, then the processor is to provide the information stored in the user storage device to the remote user.

11. The apparatus of claim 10, wherein if the backup of the information is stored in the service provider storage device, and if the information stored in the user storage device is not more recent than the backup of the information stored in the service provider storage device, then the service processor is to provide the information stored in the service provider storage device to the remote user.

12. The apparatus of claim 11, wherein if a backup of the information is not stored in the service provider storage device, then the processor is to provide the information stored in the user storage device to the remote user.

13. The apparatus of claim 10, wherein if a backup of the information is not stored in the service provider storage device, then the processor is to provide the information stored in the user storage device to the remote user.

14. The apparatus of claim 10, wherein a storage location from which information is provided to the remote user is transparent to the remote user.

15. The apparatus of claim 12, wherein a storage location from which information is provided to the remote user is transparent to the remote user.

16. The apparatus of claim 10, wherein the processor is to receive from the remote user a modified version of the information stored in the user storage device, and to store the modified version at the service provider storage device.

17. The apparatus of claim 16, the processor to send the modified version to the user storage device.

18. The apparatus of claim 16, the processor to send an indication to the user storage device that the modified version has been stored at the service provider storage device.
